(19) United States
(12) Patent Application Publication
(10) Pub. No.: US 2025/0181937 A1
(43) Pub. Date: Jun. 5, 2025

(54) LARGE LANGUAGE MODEL-BASED KNOWLEDGE MINING METHOD AND APPARATUS

(71) Applicant: Alipay (Hangzhou) Information Technology Co., Ltd., Hangzhou (CN)

(72) Inventors: Chunjing GAN, Hangzhou (CN); Binbin HU, Hangzhou (CN); Dan YANG, Hangzhou (CN); Ziqi LIU, Hangzhou (CN); Yue SHEN, Hangzhou (CN); Zhiqiang ZHANG, Hangzhou (CN); Jinjie GU, Hangzhou (CN); Jun ZHOU, Hangzhou (CN); Guannan ZHANG, Hangzhou (CN)

(21) Appl. No.: 18/968,606

(22) Filed: Dec. 4, 2024

(30) Foreign Application Priority Data
Dec. 5, 2023 (CN) 202311654784.5

(51) Int. Cl. G06N 5/022

(52) U.S. Cl. CPC G06N 5/022

(57) ABSTRACT

Embodiments of this specification provide a large language model-based knowledge mining method and apparatus. In the large language model-based knowledge mining method, structural knowledge for a source entity is obtained based on a predetermined entity graph; a candidate relation set is determined based on a target property of the source entity in the predetermined entity graph; a corresponding target relation set and inheritable knowledge are output by using a large language model and based on the structural knowledge, the candidate relation set, and additional knowledge for the source entity; a candidate entity word set corresponding to the provided relation is output by using the large language model and based on the source entity, the relation in the target relation set, and at least one of the structural knowledge, the additional knowledge, and the inheritable knowledge; and then an entity related to the source entity and a corresponding relation are obtained.

### TECHNICAL FIELD

Embodiments of this specification generally relate to the field of computer technologies, and in particular, to a large language model-based knowledge mining method and apparatus.

### BACKGROUND

Knowledge mining means to obtain information such as entities, new entity links, and new association rules from given data, and is of great significance for automatically constructing a large-scale knowledge graph (KG). With the gradual development of large language model (LLM) technologies, a large language model can achieve relatively good effects in a plurality of tasks. However, because the large language model is usually trained based on general knowledge, and the knowledge that the large language model depends on cannot be updated in a timely manner due to a very long training time, required effects usually cannot be achieved if the large language model is directly applied to a specific domain to perform knowledge mining. Therefore, how to improve effects of knowledge mining in a specific domain by using the large language model becomes a research-worthy problem.

### SUMMARY

In view of the above-mentioned descriptions, embodiments of this specification provide a large language model-based knowledge mining method and apparatus. According to the method and the apparatus, effects of knowledge mining in a specific domain can be improved by using a large language model.

According to an aspect of the embodiments of this specification, a large language model-based knowledge mining method is provided and includes: obtaining structural knowledge for a source entity based on a predetermined entity graph, where the predetermined entity graph is used to represent a property of an entity and a relation between different entities; determining a candidate relation set based on a target property of the source entity; providing the structural knowledge, the candidate relation set, and additional knowledge for the source entity to a large language model, to obtain a corresponding target relation set and inheritable knowledge, where the inheritable knowledge includes at least one target entity word corresponding to a relation in the target relation set; providing prompt information constructed based on the source entity, the relation in the target relation set, and knowledge information to the large language model, to obtain a candidate entity word set corresponding to the provided relation, where the knowledge information includes at least one of the following: the structural knowledge, the additional knowledge, and the inheritable knowledge; and obtaining an entity related to the source entity and a corresponding relation based on the obtained candidate entity word set.

According to another aspect of the embodiments of this specification, a large language model-based knowledge mining apparatus is provided and includes: a structural knowledge obtaining unit, configured to obtain structural knowledge for a source entity based on a predetermined entity graph, where the predetermined entity graph is used to represent a property of an entity and a relation between different entities; a candidate relation determining unit, configured to determine a candidate relation set based on a target property of the source entity; a large model invoking unit, configured to: provide the structural knowledge, the candidate relation set, and additional knowledge for the source entity to a large language model, to obtain a corresponding target relation set and inheritable knowledge, where the inheritable knowledge includes at least one target entity word corresponding to a relation in the target relation set; and provide prompt information constructed based on the source entity, the relation in the target relation set, and knowledge information to the large language model, to obtain a candidate entity word set corresponding to the provided relation, where the knowledge information includes at least one of the following: the structural knowledge, the additional knowledge, and the inheritable knowledge; and a mining result generation unit, configured to obtain an entity related to the source entity and a corresponding relation based on the obtained candidate entity word set.

According to still another aspect of the embodiments of this specification, a large language model-based knowledge mining apparatus is provided and includes at least one processor and a storage coupled to the at least one processor. The storage stores instructions, and when the instructions are executed by the at least one processor, the at least one processor is enabled to perform the large language model-based knowledge mining method described above.

According to yet another aspect of the embodiments of this specification, a computer-readable storage medium is provided. The computer-readable storage medium stores a computer program, and when the computer program is executed by a processor, the large language model-based knowledge mining method described above is implemented.

According to yet another aspect of the embodiments of this specification, a computer program product is provided and includes a computer program, and the computer program is executed by a processor to implement the large language model-based knowledge mining method.

### BRIEF DESCRIPTION OF DRAWINGS

The essence and advantages of the content of this specification can be further understood with reference to the following accompanying drawings. In the accompanying drawings, similar components or features can have the same reference numerals.

FIG. 1 shows an example architecture of a large language model-based knowledge mining method and apparatus according to an embodiment of this specification;

FIG. 2 is a flowchart of an example of a large language model-based knowledge mining method according to an embodiment of this specification;

FIG. 3 is a flowchart of an example of a process of determining a candidate entity word set according to an embodiment of this specification;

FIG. 4 is a flowchart of an example of a process of determining an entity related to a source entity and a corresponding relation according to an embodiment of this specification;

FIG. 5 is a flowchart of an example of a process of determining a semantic relatedness score according to an embodiment of this specification;

FIG. 6 is a flowchart of another example of a large language model-based knowledge mining method according to an embodiment of this specification;

FIG. 7 is a schematic diagram of an example of an application scenario of a large language model-based knowledge mining method according to an embodiment of this specification;

FIG. 8 is a block diagram of an example of a large language model-based knowledge mining apparatus according to an embodiment of this specification;

FIG. 9 is a block diagram of an example of a mining result generation unit in a large language model-based knowledge mining apparatus according to an embodiment of this specification; and

FIG. 10 is a schematic diagram of an example of a large language model-based knowledge mining apparatus according to an embodiment of this specification.

### DESCRIPTION OF EMBODIMENTS

The subject matter described here will be discussed below with reference to example implementations. It should be understood that these implementations are merely discussed to enable a person skilled in the art to better understand and implement the subject matter described in this specification, and are not intended to limit the protection scope, applicability, or examples described in the claims. The functions and arrangements of the elements under discussion can be changed without departing from the protection scope of the content of the embodiments of this specification. Various processes or components can be omitted, replaced, or added in the examples as needed. In addition, features described for some examples can also be combined in other examples.

As used in this specification, the term “including” and variants thereof represent open terms, and mean “including but not limited to”. The term “based on” means “at least partially based on”. The terms “one embodiment” and “an embodiment” mean “at least one embodiment”. The term “another embodiment” means “at least one other embodiment”. The terms “first”, “second”, etc. can refer to different or same objects. Other definitions can be included below, either explicitly or implicitly. Unless explicitly stated in the context, the definition of a term is consistent throughout this specification.

In this specification, the term “large language model” can be an artificial intelligence model designed to understand and generate natural languages. This model is trained by using a large amount of text data, and learns various language patterns and structures, and therefore can generate smooth and coherent text. Usually, if a specific prompt is input to the large language model, the large language model can generate content related to the prompt.

The large language model-based knowledge mining method and apparatus according to the embodiments of this specification are described below in detail with reference to the accompanying drawings.

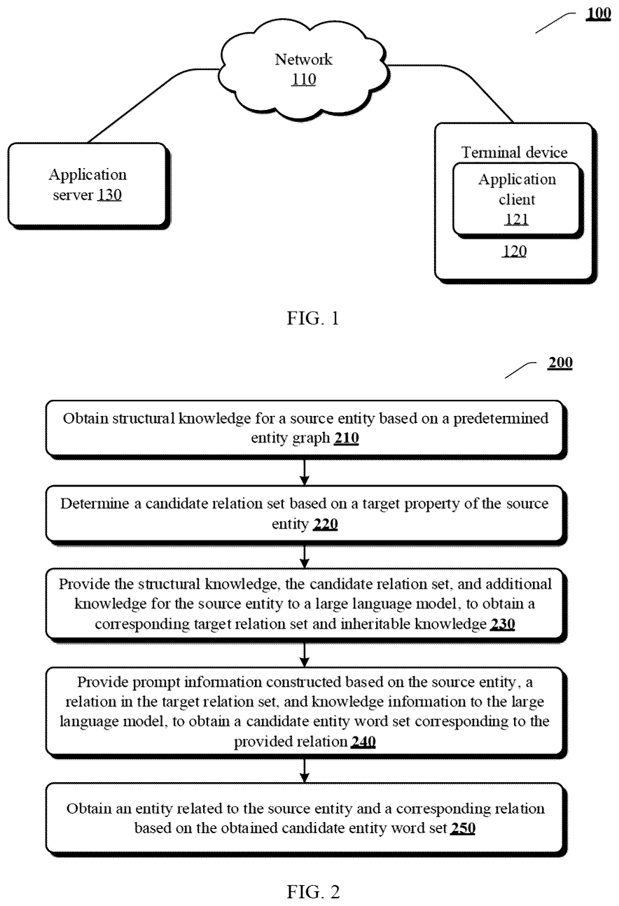

FIG. 1 shows an example architecture 100 of a large language model-based knowledge mining method and apparatus according to an embodiment of this specification.

In FIG. 1, a network 110 is applied between a terminal device 120 and an application server 130 for interconnection.

The network 110 can be any type of network that can interconnect network entities. The network 110 can be a single network or a combination of various networks. In terms of a coverage area, the network 110 can be a local area network (LAN), a wide area network (WAN), etc. In terms of a bearer medium, the network 110 can be a wired network, a wireless network, etc. In terms of data exchange technologies, the network 110 can be a circuit switched network, a packet switched network, etc.

The terminal device 120 can be any type of electronic computing device that can be connected to the network 110, access a server or website on the network 110, and process data, signals, etc. For example, the terminal device 120 can be a desktop computer, a laptop computer, a tablet computer, a smartphone, etc. Although only one terminal device is shown in FIG. 1, it should be understood that different quantities of terminal devices can be connected to the network 110.

In an implementation, the terminal device 120 can be used by a user. The terminal device 120 can include an application client (for example, an application client 121) that provides various services for the user. In some cases, the application client 121 can interact with the application server 130. For example, the application client 121 can transmit an input message to the application server 130, and receive a response related to the message from the application server 130. In this specification, the “message” can be any input information, for example, a commodity purchased by the user and input by a merchant.

The application server 130 can be configured to perform the above-mentioned large language model-based knowledge mining method, to obtain a relation representation between entities, for example, to construct a complete knowledge graph. In an example, after receiving the message transmitted by the application client 121, the application server can determine recommended commodity information that matches the commodity purchased by the user from the constructed knowledge graph, and send the recommended commodity information to the application client 121 as a response.

It should be understood that all network entities shown in FIG. 1 are examples. Based on a specific application requirement, the architecture 100 can involve any other network entities.

FIG. 2 is a flowchart of a large language model-based knowledge mining method 200 according to an embodiment of this specification.

As shown in FIG. 2, in 210, structural knowledge for a source entity is obtained based on a predetermined entity graph.

In this embodiment, the predetermined entity graph can be used to represent a property of an entity and a relation between different entities. Generally, the predetermined entity graph can be used as prior knowledge, and matches a specific domain in which knowledge mining is to be performed. In an example, for the medical field, the predetermined entity graph can be a constructed knowledge graph in the medical field. The entity can be a drug, the property of the entity can include an indication, a molecular formula, contraindications for use, etc., and the relation between entities can be “used together”, “prohibited to be simultaneously used”, etc. In an example, for the marketing field, the predetermined entity graph can be a constructed knowledge graph that includes a relation between a user and a commodity, for example, SupKG. The entity can be a commodity or a service, the property of the entity can include a price, a category, etc., and the relation between entities can be “similar commodities”, “used together”, etc.

In an example, the source entity can be located from the predetermined entity graph, and a corresponding subgraph can be extracted. A property of the source entity and a relation between the source entity and an adjacent entity that are indicated in the subgraph can be used as the structural knowledge for the source entity. In an example, a range of the subgraph can be specified in advance, for example, a one-hop neighbor or two-hop neighbor is selected.

In 220, a candidate relation set is determined based on a target property of the source entity.

In this embodiment, each candidate relation in the candidate relation set matches the target property of the source entity. In an example, candidate relation sets corresponding to different properties can be predefined. Therefore, a corresponding candidate relation set (for example, can be represented by using [symbol] ) can be determined based on the target property of the source entity.

Optionally, the property can include a type. A relation that matches a type of the source entity can be selected from the predefined relation set, to obtain the candidate relation set. In an example, the type can be used to indicate a classification of the entity. For example, a type of an entity “apple” can be a brand or food.

In an example, the above-mentioned process can be represented as

$$s {\to }^{ϕ ( \cdot ; 𝒦 ) , ℛ} {ℛ}_{s}^{𝒯} .$$

Herein, s can be used to represent the source entity, and ϕ(⋅; K) can be used to represent retrieval of a type of an entity from the predetermined entity graph K. For example, ϕ(“Air”;K)=“brand”. Based on a retrieval result, a subset, that is, the candidate relation set [symbol] , of the predefined relation set R can be obtained, for example, can include “related brand” and “target audience”. In an example, candidate relations that match different types can be predefined. For example, the predefined relation set can include “related food” and “related brand”. For a brand entity “apple”, a matching relation should be “related brand” instead of “related food”. It can be learned that there is usually a case in which | [symbol] |<<|R|.

Based on this, the candidate relation set can be limited to limited relation space by filtering out a relation that does not match an entity type. This helps make a subsequent process of expanding inheritable knowledge based on this more controllable, for example, avoiding expansion of the “related food” relation for the given brand entity “apple”, and significantly reduces a computation amount.

In 230, the structural knowledge, the candidate relation set, and additional knowledge for the source entity are provided to a large language model, to obtain a corresponding target relation set and inheritable knowledge.

In this embodiment, the additional knowledge can include various types of prior knowledge used as supplements, for example, descriptive knowledge obtained from a public or private knowledge base, to better perform knowledge mining. In an example, structural knowledge for the entity “The Three-Body Problem” can include only an entity whose type is a “science fiction novel” and that has a “related commodity” relation with the entity “The Three-Body Problem”, including “The Wandering Earth”, etc. However, descriptive knowledge for “The Three-Body Problem” can include an introduction and other information (for example, the author, the publisher, and the film and television with the same name) of “The Three-Body Problem”. The inheritable knowledge can include at least one target entity word corresponding to at least one relation in the target relation set (for example, can be represented by using [symbol] ), can be used to reflect a potential target entity word considered by the large language model in a case of a given relation, and can be subsequently used for further expansion, to obtain a related entity.

In an example, the above-mentioned process can be represented as

$${ℛ}_{s}^{𝒯} {\to }^{ℳ ( \cdot ; {ρ}^{ℛ} ( s , κ ) )} {ℛ}_{s}^{ℱ} .$$

Herein, ρ^{R}(s,κ) can be used to represent the structural knowledge and the additional knowledge for the source entity s, and M(⋅;ρ^{R}(s,κ) can be used to represent a large language model enhanced by using the structural knowledge and the additional knowledge (for example, descriptive knowledge), which can be used as a relation filter to further perform filtering from the candidate relation set [symbol] to obtain the target relation set [symbol] that matches the source entity s and the prior knowledge. In addition, correspondingly, for the at least one relation in the target relation set, the at least one target entity word in the given relation can be further obtained. For example, a target relation set of the entity “The Three-Body Problem” can include a “related book” relation, a “film and television with the same name” relation, etc. A target entity word corresponding to the “related book” relation can include “The Wandering Earth”. A target entity word corresponding to the “film and television with the same name” relation can include “The Three-Body Problem (TV series)”.

In 240, prompt information constructed based on the source entity, the relation in the target relation set, and knowledge information is provided to the large language model, to obtain a candidate entity word set corresponding to the provided relation.

In this embodiment, the knowledge information can include at least one of the following: the structural knowledge (for example, can be represented by using [symbol] ), the additional knowledge (for example, can be represented by using κ^{D}), and the inheritable knowledge (for example, can be represented by using [symbol] ). In an example, a relation r can be selected from the target relation set [symbol] , and the constructed prompt information can be represented as ρ^{∈}(s,r;k), to obtain a candidate entity word set corresponding to the relation r. Herein, K can include at least one of [symbol] , κ^{D}, and [symbol] . In this way, a candidate entity word set corresponding to each relation in the target relation set can be obtained.

Optionally, each candidate entity word in the candidate entity word set can further correspond to information about a quantity of occurrence times.

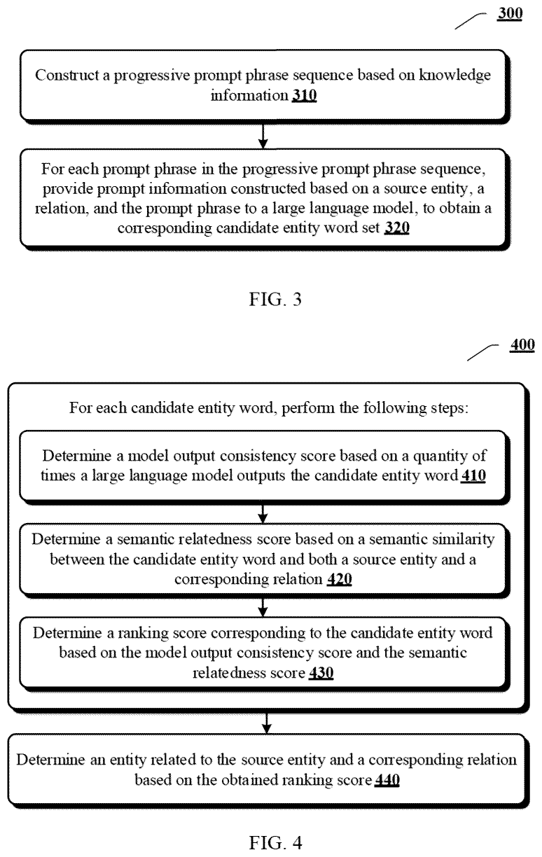

Optionally, for each relation in the target relation set, continue to refer to FIG. 3. FIG. 3 is a flowchart of an example of a process 300 of determining a candidate entity word set according to an embodiment of this specification.

As shown in FIG. 3, in 310, a progressive prompt phrase sequence is constructed based on the knowledge information.

In this embodiment, the progressive prompt phrase sequence can be constructed in a manner from a coarse granularity to a fine granularity. In an example, prompt phrases in the progressive prompt phrase sequence can be arranged in ascending order of amounts of information. In an example, the progressive prompt phrase sequence can be represented as {( [symbol] ), (κ^{D}), ( [symbol] ), ( [symbol] ,κ^{D}), . . . , ( [symbol] ,κ^{D}, [symbol] )}. In an example, the progressive prompt phrase sequence can be represented as {(κ^{D}), ( [symbol] ), ( [symbol] ), (κ^{D}, [symbol] ), . . . , (κ^{D}, [symbol] , [symbol] )}.

In 320, for each prompt phrase in the progressive prompt phrase sequence, prompt information constructed based on the source entity, the relation, and the prompt phrase is provided to the large language model, to obtain a corresponding candidate entity word set.

In an example, for the relation r in the target relation set [symbol] , the constructed prompt information can include ρ^{∈}(s,r; [symbol] ), ρ^{∈}(s,r;κ^{D}), ρ^{∈}(s,r; [symbol] ), ρ^{∈}(s,r; [symbol] ,κ^{D}), . . . , and ρ^{∈}(s,r; [symbol] ,κ^{D}, [symbol] ). Correspondingly, the large language model can output candidate entity word sets respectively corresponding to the above-mentioned prompt information. For example, the candidate entity word sets can be represented as [symbol] , [symbol] , . . . , and [symbol] . Herein, [symbol] , can be used to represent a candidate entity word set that has the relation r with the source entity s under a given condition of the i^{th} piece of prompt information. In an example, [symbol] can correspond to ρ^{∈}(s,r; [symbol] ), [symbol] can correspond to ρ^{∈}(s,r;κ^{D}), and so on.

Because of the diversity of prior knowledge and the sensitivity of prompt words in the large language model, it cannot be ensured, by using only one prompt, that a desired result is obtained regardless of how carefully the prompt is designed. Based on this, in this solution, prudent progressive prompts are designed to direct the large language model M to explore different aspects of various types of learned knowledge (for example, the prior knowledge and the inheritable knowledge), so as to obtain more diversified and more robust candidate entity word results.

As still shown in FIG. 2, in 250, an entity related to the source entity and a corresponding relation are obtained based on the obtained candidate entity word set.

In this embodiment, candidate entity words in the obtained candidate entity word set can be integrated in various manners, to obtain the entity related to the source entity and the corresponding relation. In an example, a degree of matching between the source entity, the corresponding relation, and the candidate entity word can be determined to select an entity with a higher degree of matching (for example, exceeding a preset threshold or ranked top 3) as the entity related to the source entity, and then the corresponding relation of the related entity can be determined. In an example, a quantity of occurrence times of each candidate entity word can be counted, and a candidate entity word with a larger quantity of occurrence times (for example, exceeding a preset threshold or ranked top 3) can be determined as the entity related to the source entity. Correspondingly, a relation corresponding to the determined related entity can be determined as the corresponding relation.

Optionally, continue to refer to FIG. 4. FIG. 4 is a flowchart of an example of a process 400 of determining an entity related to a source entity and a corresponding relation according to an embodiment of this specification.

As shown in FIG. 4, for each candidate entity word, the following steps 410-430 are performed.

In 410, a model output consistency score is determined based on a quantity of times the large language model outputs the candidate entity word.

In this embodiment, for a candidate entity word t, a quantity of times the large language model outputs the candidate entity word can be represented as Σₖ [symbol] (t∈ [symbol] ). Herein, k can be used to represent a total quantity of times the large language model outputs the candidate entity word set under a condition of the provided knowledge information. In an example, the quantity of times the large language model outputs the candidate entity word can be directly determined as the model output consistency score. In an example, a ratio of the quantity of times the large language model outputs the candidate entity word to the total quantity k of times can be determined as the model output consistency score.

Optionally, smoothing processing can be performed on the quantity of times the large language model outputs the candidate entity word, to obtain the model output consistency score. In an example, the above-mentioned smoothing processing can be performed by using a log function. For example, the model output consistency score can be represented as log (1+∈ₖ [symbol] (t∈ [symbol] )). Optionally, the smoothing processing can be correspondingly performed by using a sigmoid function, etc.

In 420, a semantic relatedness score is determined based on a semantic similarity between the candidate entity word and both the source entity and the corresponding relation.

In this embodiment, the semantic relatedness score is used to measure trustworthiness of semantic relatedness between the candidate entity word and the source entity in the corresponding relation. In an example, a knowledge triple can be formed by using the source entity, the corresponding relation, and the candidate entity word, and then the corresponding semantic relatedness score can be obtained by using various knowledge graph triple trustworthiness measurement methods.

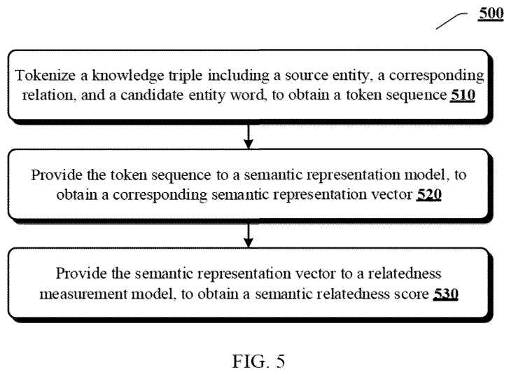

Optionally, continue to refer to FIG. 5. FIG. 5 is a flowchart of an example of a process 500 of determining a semantic relatedness score according to an embodiment of this specification.

As shown in FIG. 5, in 510, a knowledge triple including the source entity, the corresponding relation, and the candidate entity word is tokenized, to obtain a token sequence.

In an example, for a knowledge triple (s,r,t) including the source entity s, the corresponding relation r, and the candidate entity word t, the token sequence can be represented as {CLS>, z₁^{s}, . . . , zₐ^{s}, <SEP>, z₁^{r}, . . . , z_{b}^{r}, <SEP>, z₁^{t}, . . . , z_{c}^{t}, <SEP>}. The source entity can be represented as a sentence including tokens z₁^{s}, . . . , and zₐ^{s}. The corresponding relation can be represented as a sentence including tokens z₁^{r}, . . . , and z_{b}^{r}. The candidate entity word can be represented as a sentence including tokens z₁^{t}, . . . , and z_{c}^{t}.

In 520, the token sequence is provided to a semantic representation model, to obtain a corresponding semantic representation vector.

In this embodiment, the semantic representation model can include various language models that have related knowledge. In an example, the semantic representation model can be a model, for example, a KG-BERT model, obtained through training by using a mixed corpus including general knowledge (for example, Wikipedia) and specific domain knowledge (for example, the above-mentioned predetermined entity graph).

In an example, the semantic representation model can obtain a context representation of each token in the token sequence. In an example, a context representation corresponding to the token <CLS> can be used as the semantic representation vector corresponding to the knowledge triple indicated by the token sequence. Optionally, obtained context representations of tokens can be fused in another manner, to obtain the semantic representation vector corresponding to the knowledge triple.

In 530, the semantic representation vector is provided to a relatedness measurement model, to obtain the semantic relatedness score.

In this embodiment, the relatedness measurement model can be used to map the semantic representation vector to the semantic relatedness score. In an example, the relatedness measurement model can be a multilayer perceptron (MLP) obtained through pre-training. For example, the semantic relatedness score can be represented as MLP(x_{s,r,t}). Herein, x_{s,r,t} can be used to represent the semantic representation vector corresponding to the knowledge triple (s,r,t).

Based on this, this solution provides a method for converting the semantic similarity between the candidate entity word and both the source entity and the corresponding relation into the relatedness score corresponding to the knowledge triple including the source entity, the corresponding relation, and the candidate entity word, and specifically provides a technical solution for determining the semantic relatedness score by using a combination of the semantic representation model and the relatedness measurement model.

As still shown in FIG. 4, in 430, a ranking score corresponding to the candidate entity word is determined based on the model output consistency score and the semantic relatedness score.

In this embodiment, the model output consistency score and the semantic relatedness score can be combined in various manners, to determine the ranking score corresponding to the candidate entity word. In an example, a weighted summation manner can be used for combination.

Optionally, a product of the model output consistency score and the semantic relatedness score can be determined as the ranking score corresponding to the candidate entity word. In an example, the ranking score corresponding to the candidate entity word can be represented as τ_{s,r,t}=log (1+Σₖ [symbol] (t∈ [symbol] ))·MLP (x_{s,r,t}). For meanings of related symbols, refer to the above-mentioned descriptions.

In 440, the entity related to the source entity and the corresponding relation are determined based on the obtained ranking score.

In this embodiment, the entity related to the source entity can be determined from the candidate entity word set based on the obtained ranking score. In an example, for each relation in the target relation set, a candidate entity word with a higher ranking score (for example, several candidate entity words with highest ranking scores or a candidate entity word with a ranking score greater than a predetermined threshold) corresponding to the relation can be selected as the entity related to the source entity. In an example, a candidate entity word with a higher ranking score (for example, several candidate entity words with highest ranking scores or a candidate entity word with a ranking score greater than a predetermined threshold) can be selected from the obtained ranking score as the entity related to the source entity, and a relation corresponding to the selected related entity can be determined as the corresponding relation.

Based on this, in this solution, the ranking score is obtained through aggregation and by comprehensively considering the model output consistency score and the semantic relatedness score. This reflects a technical concept of combining the consistency degree of the result output by the large language model by performing inference in a plurality of manners and the trustworthiness of the knowledge triple and reliably evaluating the candidate entity word in terms of logical self-consistency of the large language model and semantic relatedness of the knowledge triple, thereby effectively improving accuracy of the knowledge mining result.

As still shown in FIG. 2, optionally, a first training sample set can be further obtained based on the obtained target relation set and inheritable knowledge and the corresponding structural knowledge, candidate relation set, and additional knowledge for the source entity for which verification succeeds. In an example, whether the obtained target relation set and inheritable knowledge match the corresponding input structural knowledge, candidate relation set, and additional knowledge for the source entity can be manually verified, and the target relation set and inheritable knowledge and the corresponding structural knowledge, candidate relation set, and additional knowledge for the source entity for which verification succeeds are used as a training sample in the first training sample set.

Optionally, a second training sample set can be further obtained based on the obtained candidate entity word set corresponding to the provided relation and the corresponding prompt information constructed based on the source entity, the relation in the target relation set, and the knowledge information for which verification succeeds. In an example, whether the obtained candidate entity word set corresponding to the provided relation matches the corresponding input prompt information constructed based on the source entity, the relation in the target relation set, and the knowledge information can be manually verified, and the candidate entity word set corresponding to the provided relation and the corresponding prompt information constructed based on the source entity, the relation in the target relation set, and the knowledge information for which verification succeeds are used as a training sample in the second training sample set.

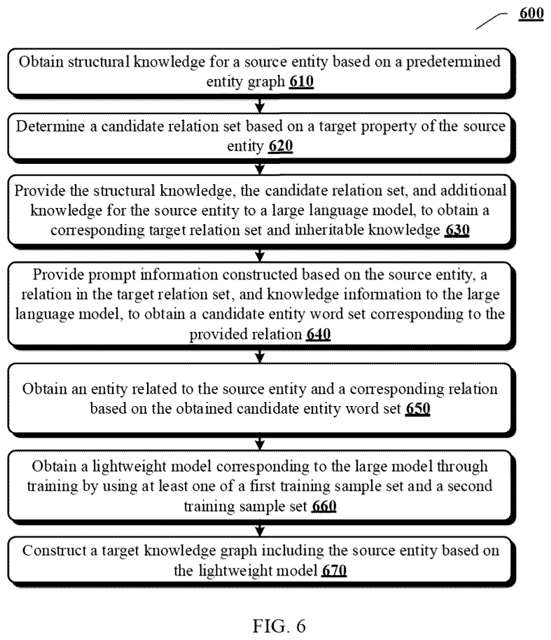

Reference is made below to FIG. 6. FIG. 6 is a flowchart of another example of a large language model-based knowledge mining method 600 according to an embodiment of this specification.

As shown in FIG. 6, in 610, structural knowledge for a source entity is obtained based on a predetermined entity graph.

In 620, a candidate relation set is determined based on a target property of the source entity.

In 630, the structural knowledge, the candidate relation set, and additional knowledge for the source entity are provided to a large language model, to obtain a corresponding target relation set and inheritable knowledge.

In 640, prompt information constructed based on the source entity, a relation in the target relation set, and knowledge information is provided to the large language model, to obtain a candidate entity word set corresponding to the provided relation.

In 650, an entity related to the source entity and a corresponding relation are obtained based on the obtained candidate entity word set.

It should be noted that for steps 610-650, refer to the related descriptions of steps 210-250 in the embodiment in FIG. 2 and the related descriptions in the embodiments in FIG. 3 to FIG. 5. Details are not described herein.

In 660, a lightweight model corresponding to the large model is obtained through training by using at least one of a first training sample set and a second training sample set.

In this embodiment, the lightweight model corresponding to the large model can be obtained through training by using at least one of the first training sample set and the second training sample set in a knowledge distillation (for example, teacher-student) manner. In an example, the lightweight model can include various disclosed pre-trained language models with a smaller quantity of parameters than a general large language model, for example, a BLOOMZ model, a GLM model, and a ChatGLM model. In an example, the structural knowledge, the candidate relation set, and the additional knowledge for the source entity in the first training sample set can be used as inputs, and the corresponding target relation set and inheritable knowledge can be used as expected outputs. In an example, the prompt information constructed based on the source entity, the relation in the target relation set, and the knowledge information in the second training sample set can be used as an input, and the corresponding candidate entity word set corresponding to the input relation can be used as an expected output. The lightweight model corresponding to the large model can be obtained through training by using the above-mentioned supervised fine tuning process.

In 670, a target knowledge graph including the source entity is constructed based on the lightweight model.

In this embodiment, based on an existing relation between entities, steps 610-650 can be repeatedly performed by constantly selecting a new source entity and by using the lightweight model, to construct the target knowledge graph including the source entity.

Based on this, in this solution, a training sample can be generated by using a knowledge mining result obtained by using the large language model, a more lightweight and smaller knowledge mining task-oriented model is obtained through training in a fine tuning manner, and the model is applied to subsequent entity expansion and construction of the target knowledge graph. In this way, while effects comparable to those of the large language model in a same task are achieved, a memory and computing resources can be greatly saved and efficiency can be improved.

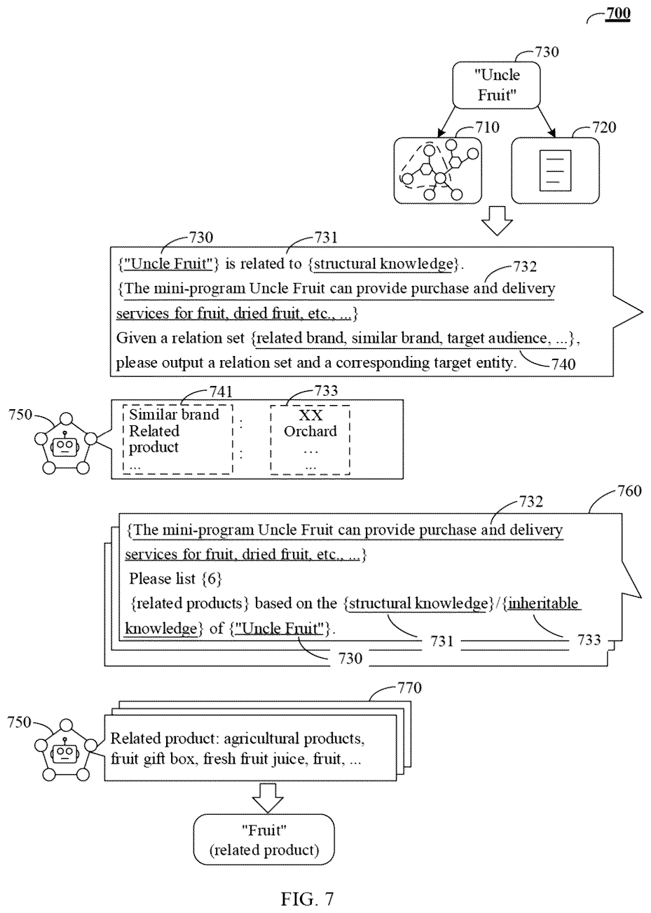

Reference is made below to FIG. 7. FIG. 7 is a schematic diagram of an example of an application scenario 700 of a large language model-based knowledge mining method according to an embodiment of this specification.

As shown in FIG. 7, structural knowledge 731 and descriptive knowledge “The mini-program Uncle Fruit can provide purchase and delivery services for fruit, dried fruit, etc., . . . ” 732 for “Uncle Fruit” 730 can be respectively obtained from a predetermined entity graph 710 and a knowledge base (for example, encyclopedia) 720. The structural knowledge 731 can include, for example, “type: brand” and another entity (for example, “XX fresh fruit”) related to “Uncle Fruit”. A candidate relation set “related brand, similar brand, target audience, . . . ” 740 can be determined based on a target property (for example, “brand”) of “Uncle Fruit” 730 in the predetermined entity graph 710. Then, the structural knowledge 731, the descriptive knowledge 732, and the candidate relation set 740 for “Uncle Fruit” 730 can be provided to a large language model 750, to obtain a corresponding target relation set “similar brand, target audience” 741 and inheritable knowledge “XX Orchard (being a similar brand)” “ . . . (being a related product” 733. Then, at least one piece of prompt information 760 can be constructed based on “Uncle Fruit” 730, a relation (for example, “related product”) in the target relation set 741, and at least one of the structural knowledge 731, the descriptive knowledge 732, and the inheritable knowledge 733. The at least one piece of constructed prompt information 760 is provided to the large language model 750, to obtain a candidate entity word set 770 (for example, “agricultural products”, “fruit gift box”, “fresh fruit juice”, and “fruit”) corresponding to the provided relation (for example, “related product”). Then, aggregation is performed based on the obtained candidate entity word set 770, to further determine an entity (for example, “fruit”) related to “Uncle Fruit” 730 and a corresponding relation (for example, “related product”).

According to the large language model-based knowledge mining method disclosed in FIG. 1 to FIG. 7, structural knowledge for a source entity obtained based on a predetermined entity graph can be used as domain knowledge, and a candidate relation set is determined based on this. Then, the domain knowledge and the determined candidate relation set are further provided to a large language model, and an understanding capability of the large language model for the specific domain knowledge is further improved by introducing additional knowledge, thereby improving accuracy of filtering candidate relationships and generating inheritable knowledge. Then, a corresponding candidate entity set is obtained by using the large language model and with reference to the source entity, the obtained relation, and various types of related knowledge, and finally an entity related to the source entity and a corresponding relation are obtained. Therefore, by introducing designed prior knowledge to the large language model, efficient and accurate knowledge mining is implemented.

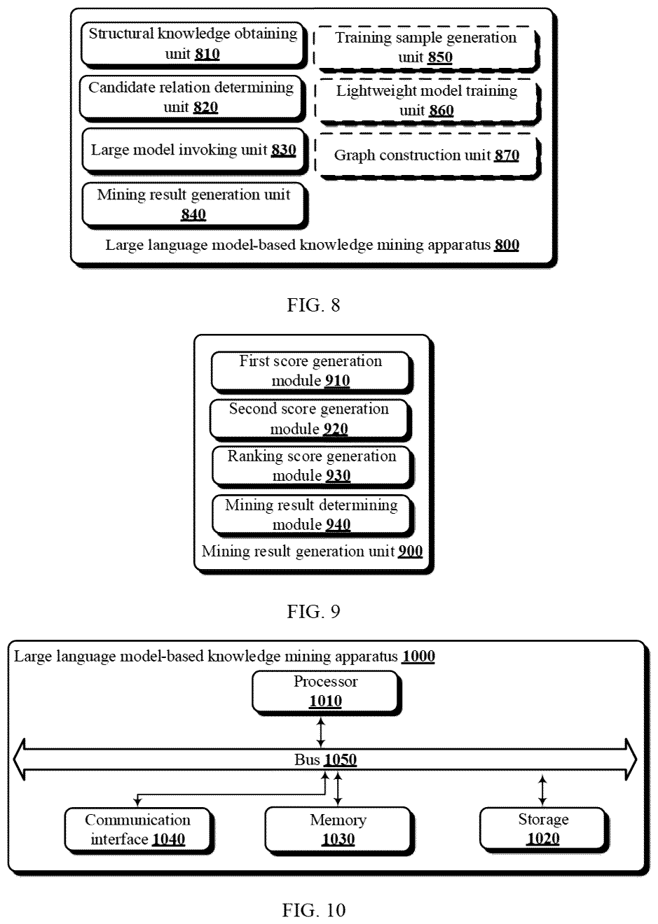

FIG. 8 is a block diagram of an example of a large language model-based knowledge mining apparatus 800 according to an embodiment of this specification; This apparatus embodiment can correspond to the method embodiments shown in FIG. 2 to FIG. 7, and the apparatus can be specifically applied to various electronic devices.

As shown in FIG. 8, the large language model-based knowledge mining apparatus 800 can include a structural knowledge obtaining unit 810, a candidate relation determining unit 820, a large model invoking unit 830, and a mining result generation unit 840.

The structural knowledge obtaining unit 810 is configured to obtain structural knowledge for a source entity based on a predetermined entity graph. The predetermined entity graph is used to represent a property of an entity and a relation between different entities. For an operation of the structural knowledge obtaining unit 810, refer to the operation in 210 described in FIG. 2.

The candidate relation determining unit 820 is configured to determine a candidate relation set based on a target property of the source entity. For an operation of the candidate relation determining unit 820, refer to the operation in 220 described in FIG. 2.

In an example, the property includes a type. The candidate relation determining unit 820 is further configured to select a relation that matches a type of the source entity from a predefined relation set, to obtain the candidate relation set.

The large model invoking unit 830 is configured to: provide the structural knowledge, the candidate relation set, and additional knowledge for the source entity to a large language model, to obtain a corresponding target relation set and inheritable knowledge; and provide prompt information constructed based on the source entity, a relation in the target relation set, and knowledge information to the large language model, to obtain a candidate entity word set corresponding to the provided relation. The inheritable knowledge includes at least one target entity word corresponding to the relation in the target relation set. The knowledge information includes at least one of the following: the structural knowledge, the additional knowledge, and the inheritable knowledge. For operations of the large model invoking unit 830, refer to the operations in 230-240 described in FIG. 2.

In an example, the large model invoking unit 830 is further configured to: for each relation in the target relation set, construct a progressive prompt phrase sequence based on the knowledge information; and for each prompt phrase in the progressive prompt phrase sequence, provide prompt information constructed based on the source entity, the relation, and the prompt phrase to the large language model, to obtain a corresponding candidate entity word set. For operations of the large model invoking unit 830, refer to the operations in 310-320 described in FIG. 3.

The mining result generation unit 840 is configured to obtain an entity related to the source entity and a corresponding relation based on the obtained candidate entity word set. For an operation of the mining result generation unit 840, refer to the operation in 250 described in FIG. 2.

In an example, optionally, continue to refer to FIG. 9. FIG. 9 is a block diagram of an example of a mining result generation unit 900 in a large language model-based knowledge mining apparatus according to an embodiment of this specification.

As shown in FIG. 9, the mining result generation unit 900 includes: a first score generation module 910, configured to: for each candidate entity word, determine a model output consistency score based on a quantity of times the large language model outputs the candidate entity word; a second score generation module 920, configured to: for each candidate entity word, determine a semantic relatedness score based on a semantic similarity between the candidate entity word and both the source entity and the corresponding relation; a ranking score generation module 930, configured to: for each candidate entity word, determine a ranking score corresponding to the candidate entity word based on the model output consistency score and the semantic relatedness score; and a mining result determining module 940, configured to determine the entity related to the source entity and the corresponding relation based on the obtained ranking score. For operations of the first score generation module 910, the second score generation module 920, the ranking score generation module 930, and the mining result determining module 940, refer to the operations in 410-440 described in FIG. 4.

In an example, the second score generation module 920 is further configured to: tokenize a knowledge triple including the source entity, the corresponding relation, and the candidate entity word, to obtain a token sequence; provide the token sequence to a semantic representation model, to obtain a corresponding semantic representation vector; and provide the semantic representation vector to a relatedness measurement model, to obtain the semantic relatedness score. For operations of the second score generation module 920, refer to the operations in 510-530 described in FIG. 5.

In an example, the first score generation module 910 is further configured to perform smoothing processing on the quantity of times the large language model outputs the candidate entity word, to obtain the model output consistency score. The ranking score generation module 930 is further configured to determine a product of the model output consistency score and the semantic relatedness score as the ranking score corresponding to the candidate entity word. For operations of the first score generation module 910 and the ranking score generation module 930, refer to the operations in the optional implementations in 410 and 430 described in FIG. 4.

As still shown in FIG. 8, optionally, the large language model-based knowledge mining apparatus 800 can further include a training sample generation unit 850. In an example, the training sample generation unit 850 can be configured to obtain a first training sample set based on the obtained target relation set and inheritable knowledge and the corresponding structural knowledge, candidate relation set, and additional knowledge for the source entity for which verification succeeds. In an example, the training sample generation unit 850 can be configured to obtain a second training sample set based on the obtained candidate entity word set corresponding to the provided relation and the corresponding prompt information constructed based on the source entity, the relation in the target relation set, and the knowledge information for which verification succeeds.

Optionally, the large language model-based knowledge mining apparatus 800 can further include: a lightweight model training unit 860, configured to obtain a lightweight model corresponding to the large model through training by using at least one of the first training sample set and the second training sample set; and a graph construction unit 870, configured to construct a target knowledge graph including the source entity based on the lightweight model.

For operations of the training sample generation unit 850, the lightweight model training unit 860, and the graph construction unit 870, refer to the optional implementation described in FIG. 2 and the operations in 660-670 described in FIG. 6.

The embodiments of the large language model-based knowledge mining method and apparatus according to the embodiments of this specification are described above with reference to FIG. 1 to FIG. 9.

The large language model-based knowledge mining apparatus in the embodiments of this specification can be implemented by using hardware, or can be implemented by using software or a combination of hardware and software. Software implementation is used as an example. As a logical apparatus, the apparatus is formed by reading corresponding computer program instructions in a storage to a memory by a processor of a device in which the apparatus is located. In the embodiments of this specification, the large language model-based knowledge mining apparatus can be implemented by using, for example, an electronic device.

FIG. 10 is a schematic diagram of an example of a large language model-based knowledge mining apparatus 1000 according to an embodiment of this specification.

As shown in FIG. 10, the large language model-based knowledge mining apparatus 1000 can include at least one processor 1010, a storage (for example, a nonvolatile memory) 1020, a memory 1030, and a communication interface 1040, and the at least one processor 1010, the storage 1020, the memory 1030, and the communication interface 1040 are connected together through a bus 1050. The at least one processor 1010 executes at least one computer-readable instruction (namely, the above-mentioned element implemented in a software form) stored or encoded in the storage.

In an embodiment, the storage stores computer-executable instructions. When the computer-executable instructions are executed, the at least one processor 1010 is enabled to perform the following operations: obtaining structural knowledge for a source entity based on a predetermined entity graph, where the predetermined entity graph is used to represent a property of an entity and a relation between different entities; determining a candidate relation set based on a target property of the source entity; providing the structural knowledge, the candidate relation set, and additional knowledge for the source entity to a large language model, to obtain a corresponding target relation set and inheritable knowledge, where the inheritable knowledge includes at least one target entity word corresponding to a relation in the target relation set; providing prompt information constructed based on the source entity, the relation in the target relation set, and knowledge information to the large language model, to obtain a candidate entity word set corresponding to the provided relation, where the knowledge information includes at least one of the following: the structural knowledge, the additional knowledge, and the inheritable knowledge; and obtaining an entity related to the source entity and a corresponding relation based on the obtained candidate entity word set.

It should be understood that when the computer-executable instructions stored in the storage are executed, the at least one processor 1010 is enabled to perform the operations and functions described above with reference to FIG. 1 to FIG. 7 in the embodiments of this specification.

According to an embodiment, a program product such as a computer-readable medium is provided. The computer-readable medium can have instructions (namely, the above-mentioned element implemented in a software form). When the instructions are executed by a computer, the computer is enabled to perform the operations and functions described above with reference to FIG. 1 to FIG. 7 in the embodiments of this specification.

Specifically, a system or an apparatus in which a readable storage medium is disposed can be provided, and software program code for implementing a function in any one of the above-mentioned embodiments is stored in the readable storage medium, so that a computer or a processor of the system or the apparatus reads and executes instructions stored in the readable storage medium.

In this case, the program code read from the readable medium can implement the function in any one of the above-mentioned embodiments. Therefore, the machine-readable code and the readable storage medium that stores the machine-readable code form a part of this specification.

Computer program code needed for operation of each part of this specification can be compiled in any one or more programming languages, including an object-oriented programming language such as Java, Scala, Smalltalk, Eiffel, JADE, Emerald, C++, C#, VB, NET, and Python, a conventional programming language such as a C language, Visual Basic 2003, Perl, COBOL 2002, PHP, and ABAP, a dynamic programming language such as Python, Ruby, and Groovy, or another programming language. The program code can run on a user computer, or run as a standalone software package on the user computer, or partially run on the user computer and partially run on a remote computer, or completely run on the remote computer or a server. In the latter case, the remote computer can be connected to the user computer in any form of network, such as a local area network (LAN) or a wide area network (WAN), or connected to an external computer (for example, via the Internet), or in a cloud computing environment, or used as a service, such as software as a service (SaaS).

Embodiments of the readable storage medium include a floppy disk, a hard disk, a magneto-optical disk, an optical disc (such as a CD-ROM, a CD-R, a CD-RW, a DVD-ROM, a DVD-RAM, and a DVD-RW), a magnetic tape, a nonvolatile memory card, and a ROM. Alternatively, program code can be downloaded from a server computer or cloud through a communication network.

Specific embodiments of this specification are described above. Other embodiments fall within the scope of the appended claims. In some cases, the actions or steps described in the claims can be performed in a sequence different from that in the embodiments and desired results can still be achieved. In addition, the process depicted in the accompanying drawings does not necessarily need a particular sequence or consecutive sequence to achieve the desired results. In some implementations, multi-tasking and parallel processing are feasible or may be advantageous.

Not all steps and units in the above-mentioned procedures and system structure diagrams are necessary. Some steps or units can be ignored based on actual requirements. An execution sequence of the steps is not fixed, and can be determined based on a requirement. The apparatus structure described in the above-mentioned embodiments can be a physical structure, or can be a logical structure. In other words, some units can be implemented by the same physical entity, or some units can be implemented by a plurality of physical entities or implemented jointly by some components in a plurality of independent devices.

The term “example” used throughout this specification means “used as an example, an instance, or an illustration” and does not mean “preferred” or “advantageous” over other embodiments. Specific implementations include specific details for the purpose of providing an understanding of the described technologies. However, these technologies can be implemented without these specific details. In some instances, well-known structures and apparatuses are shown in block diagram forms, to avoid difficulty in understanding the concept in the described embodiments.

Optional implementations of the embodiments of this specification are described above in detail with reference to the accompanying drawings. However, the embodiments of this specification are not limited to specific details in the above-mentioned implementations. Within a technical concept scope of the embodiments of this specification, a plurality of simple variations can be made to the technical solutions in the embodiments of this specification, and these simple variations all fall within the protection scope of the embodiments of this specification.

The above-mentioned descriptions of the content in this specification are provided to enable any person of ordinary skill in the art to implement or use the content in this specification. It is clear to a person of ordinary skill in the art that various modifications can be made to the content in this specification. In addition, the general principle defined in this specification can be applied to another variant without departing from the protection scope of the content in this specification. Therefore, the content in this specification is not limited to the examples and designs described herein, but is consistent with the widest range of principles and novelty features that conform to this specification.

1. A large language model-based knowledge mining method, comprising:
obtaining structural knowledge for a source entity based on a predetermined entity graph, wherein the predetermined entity graph is used to represent a property of an entity and a relation between different entities;
determining a candidate relation set based on a target property of the source entity;
providing the structural knowledge, the candidate relation set, and additional knowledge for the source entity to a large language model, to obtain a corresponding target relation set and inheritable knowledge, wherein the inheritable knowledge comprises at least one target entity word corresponding to a relation in the target relation set;
providing prompt information constructed based on the source entity, the relation in the target relation set, and knowledge information to the large language model, to obtain a candidate entity word set corresponding to the provided relation, wherein the knowledge information comprises at least one of the following: the structural knowledge, the additional knowledge, and the inheritable knowledge; and
obtaining an entity related to the source entity and a corresponding relation based on the obtained candidate entity word set.

2. The method according to claim 1, wherein the property comprises a type; and
the determining a candidate relation set based on a target property of the source entity comprises:
selecting a relation that matches a type of the source entity from a predefined relation set, to obtain the candidate relation set.

3. The method according to claim 1, wherein the providing prompt information constructed based on the source entity, the relation in the target relation set, and knowledge information to the large language model, to obtain a candidate entity word set corresponding to the provided relation comprises:
for each relation in the target relation set, constructing a progressive prompt phrase sequence based on the knowledge information; and
for each prompt phrase in the progressive prompt phrase sequence, providing prompt information constructed based on the source entity, the relation, and the prompt phrase to the large language model, to obtain a corresponding candidate entity word set.

4. The method according to claim 3, wherein the obtaining an entity related to the source entity and a corresponding relation based on the obtained candidate entity word set comprises:
for each candidate entity word, determining a model output consistency score based on a quantity of times the large language model outputs the candidate entity word;
determining a semantic relatedness score based on a semantic similarity between the candidate entity word and both the source entity and the corresponding relation;
determining a ranking score corresponding to the candidate entity word based on the model output consistency score and the semantic relatedness score; and
determining the entity related to the source entity and the corresponding relation based on the obtained ranking score.

5. The method according to claim 4, wherein the determining a semantic relatedness score based on a semantic similarity between the candidate entity word and both the source entity and the corresponding relation comprises:
tokenizing a knowledge triple comprising the source entity, the corresponding relation, and the candidate entity word, to obtain a token sequence;
providing the token sequence to a semantic representation model, to obtain a corresponding semantic representation vector; and
providing the semantic representation vector to a relatedness measurement model, to obtain the semantic relatedness score.

6. The method according to claim 4, wherein the determining a model output consistency score based on a quantity of times the large language model outputs the candidate entity word comprises:
performing smoothing processing on the quantity of times the large language model outputs the candidate entity word, to obtain the model output consistency score; and
the determining a ranking score corresponding to the candidate entity word based on the model output consistency score and the semantic relatedness score comprises:
determining a product of the model output consistency score and the semantic relatedness score as the ranking score corresponding to the candidate entity word.

7. The method according to claim 1, wherein the method further comprises:
obtaining a first training sample set based on the obtained target relation set and inheritable knowledge and the corresponding structural knowledge, candidate relation set, and additional knowledge for the source entity for which verification succeeds.

8. The method according to claim 1, wherein the method further comprises:
obtaining a second training sample set based on the obtained candidate entity word set corresponding to the provided relation and the corresponding prompt information constructed based on the source entity, the relation in the target relation set, and the knowledge information for which verification succeeds.

9. The method according to claim 7, wherein the method further comprises:
obtaining a lightweight model corresponding to the large model through training by using at least one of the first training sample set and the second training sample set; and
constructing a target knowledge graph comprising the source entity based on the lightweight model.

10. A non-transitory computer-readable storage medium, wherein the computer-readable storage medium stores a computer program, and when the computer program is executed in a computer, the computer is enabled to perform a large language model-based knowledge mining method, and the method comprising:
obtaining structural knowledge for a source entity based on a predetermined entity graph, wherein the predetermined entity graph is used to represent a property of an entity and a relation between different entities;
determining a candidate relation set based on a target property of the source entity;
providing the structural knowledge, the candidate relation set, and additional knowledge for the source entity to a large language model, to obtain a corresponding target relation set and inheritable knowledge, wherein the inheritable knowledge comprises at least one target entity word corresponding to a relation in the target relation set;
providing prompt information constructed based on the source entity, the relation in the target relation set, and knowledge information to the large language model, to obtain a candidate entity word set corresponding to the provided relation, wherein the knowledge information comprises at least one of the following: the structural knowledge, the additional knowledge, and the inheritable knowledge; and
obtaining an entity related to the source entity and a corresponding relation based on the obtained candidate entity word set.

11. The non-transitory computer-readable storage medium according to claim 10, wherein the property comprises a type; and
the determining a candidate relation set based on a target property of the source entity comprises:
selecting a relation that matches a type of the source entity from a predefined relation set, to obtain the candidate relation set.

12. A computing device, comprising a memory and a processor, wherein the memory stores executable code, and when the processor executes the executable code, the processor is caused to implement a large language model-based knowledge mining method, and the method comprising:
obtaining structural knowledge for a source entity based on a predetermined entity graph, wherein the predetermined entity graph is used to represent a property of an entity and a relation between different entities;
determining a candidate relation set based on a target property of the source entity;
providing the structural knowledge, the candidate relation set, and additional knowledge for the source entity to a large language model, to obtain a corresponding target relation set and inheritable knowledge, wherein the inheritable knowledge comprises at least one target entity word corresponding to a relation in the target relation set;
providing prompt information constructed based on the source entity, the relation in the target relation set, and knowledge information to the large language model, to obtain a candidate entity word set corresponding to the provided relation, wherein the knowledge information comprises at least one of the following: the structural knowledge, the additional knowledge, and the inheritable knowledge; and
obtaining an entity related to the source entity and a corresponding relation based on the obtained candidate entity word set.

13. The computing device according to claim 12, wherein the property comprises a type; and
the determining a candidate relation set based on a target property of the source entity comprises:
selecting a relation that matches a type of the source entity from a predefined relation set, to obtain the candidate relation set.

14. The computing device according to claim 12, wherein the providing prompt information constructed based on the source entity, the relation in the target relation set, and knowledge information to the large language model, to obtain a candidate entity word set corresponding to the provided relation comprises:
for each relation in the target relation set, constructing a progressive prompt phrase sequence based on the knowledge information; and
for each prompt phrase in the progressive prompt phrase sequence, providing prompt information constructed based on the source entity, the relation, and the prompt phrase to the large language model, to obtain a corresponding candidate entity word set.

15. The computing device according to claim 14, wherein the obtaining an entity related to the source entity and a corresponding relation based on the obtained candidate entity word set comprises:
for each candidate entity word, determining a model output consistency score based on a quantity of times the large language model outputs the candidate entity word;
determining a semantic relatedness score based on a semantic similarity between the candidate entity word and both the source entity and the corresponding relation;
determining a ranking score corresponding to the candidate entity word based on the model output consistency score and the semantic relatedness score; and
determining the entity related to the source entity and the corresponding relation based on the obtained ranking score.

16. The computing device according to claim 15, wherein the determining a semantic relatedness score based on a semantic similarity between the candidate entity word and both the source entity and the corresponding relation comprises:
tokenizing a knowledge triple comprising the source entity, the corresponding relation, and the candidate entity word, to obtain a token sequence;
providing the token sequence to a semantic representation model, to obtain a corresponding semantic representation vector; and
providing the semantic representation vector to a relatedness measurement model, to obtain the semantic relatedness score.

17. The computing device according to claim 15, wherein the determining a model output consistency score based on a quantity of times the large language model outputs the candidate entity word comprises:
performing smoothing processing on the quantity of times the large language model outputs the candidate entity word, to obtain the model output consistency score; and
the determining a ranking score corresponding to the candidate entity word based on the model output consistency score and the semantic relatedness score comprises:
determining a product of the model output consistency score and the semantic relatedness score as the ranking score corresponding to the candidate entity word.

18. The computing device according to claim 12, wherein the computing device is further caused to:
obtain a first training sample set based on the obtained target relation set and inheritable knowledge and the corresponding structural knowledge, candidate relation set, and additional knowledge for the source entity for which verification succeeds.

19. The computing device according to claim 12, wherein the computing device is further caused to:
obtain a second training sample set based on the obtained candidate entity word set corresponding to the provided relation and the corresponding prompt information constructed based on the source entity, the relation in the target relation set, and the knowledge information for which verification succeeds.

20. The computing device according to claim 18, wherein the computing device is further caused to:
obtain a lightweight model corresponding to the large model through training by using at least one of the first training sample set and the second training sample set; and
construct a target knowledge graph comprising the source entity based on the lightweight model.
